(19) United States
(12) Patent Application Publication
(10) Pub. No.: US 2015/0227733 A1
(43) Pub. Date: Aug. 13, 2015

(54) AUTOMATIC LOGIN SYSTEM AND AUTOMATIC LOGIN METHOD

(71) Applicant: HYUNDAI MOTOR COMPANY, Seoul (KR)

(72) Inventor: Kanghi Yu, Seoul (KR)

(21) Appl. No.: 14/543,938

(22) Filed: Nov. 18, 2014

(30) Foreign Application Priority Data
Feb. 10, 2014 (KR) 10-2014-0015079

(51) Int. Cl. G06F 21/31

(52) U.S. Cl. CPC G06F 21/31

(57) ABSTRACT

An automatic login system and method are provided. The system includes a terminal that is configured to generate a unique number based on an input ID and store the ID and an authentication key. An authentication server is configured to approve an initial login by comparing the input ID and an input password with a previously stored ID and password, and store the ID, the password, the authentication key, and the unique number. The terminal is also configured to regenerate the unique number based on the input ID, and the authentication server is configured to approve an automatic login using the input ID, the authentication key, and the unique regenerated number, and the stored ID, the stored authentication key, and the stored unique number stored in the authentication server.

### CROSS-REFERENCE TO RELATED APPLICATION

This application claims priority to and the benefit of Korean Patent Application No. 10-2014-0015079 filed in the Korean Intellectual Property Office on Feb. 10, 2014, the entire contents of which are incorporated herein by reference.

### BACKGROUND

(a) Field of the Invention

The present invention relates to an automatic login system and method. More particularly, the present invention relates to an automatic login system and method that improve identification (ID) and password security.

(b) Description of the Related Art

With the increase in smart phone use, the various functions of a smart phone are also increasing such as computer communication and schedule management. Thus, to use various functions of the smart phone, users operate an application of the smart phone and log on to the smart phone by inputting an ID and a password. Conventionally, users automatically log on to the smart phone without inputting an ID and a password when users use the smart phone application. However, the conventional automatic login of the smart phone stores the ID and the password in a memory and reuses the ID and the password. Thus, when the memory of the smart phone is hacked (e.g., accessed by an unauthorized user), the ID and the password may be stolen.

The above information disclosed in this section is merely for enhancement of understanding of the background of the invention and therefore it may contain information that does not form the prior art that is already known in this country to a person of ordinary skill in the art.

### SUMMARY

The present invention provides an automatic login system and method having advantages of improving ID and password security. The technical objects of the present invention are not limited to the above described technical objects, and other technical objects will be understood by those skilled in the art from the following description.

An exemplary embodiment of the present invention provides an automatic login system that may include: a terminal configured to generate a unique number based on an input ID and store the ID and an authentication key; and an authentication server configured to approve an initial login by comparing the ID and an input password with a previously stored ID and password, and store the ID, the password, the authentication key, and the unique number, wherein the terminal regenerates the unique number based on the ID, and the authentication server approves an automatic login using the ID, the authentication key, and the unique regenerated number, and the ID, the authentication key, and the unique number stored in the authentication server.

The authentication server may be configured to generate the authentication key when the ID and the password are the same as the stored ID and the stored password. The authentication server may also be configured to approve the automatic login when the ID, the authentication key, and the unique regenerated number are the same as the stored ID, the stored authentication key, and the stored unique number in the authentication server. The terminal may include an input module, and may be configured to receive the ID and the password via the input module. The terminal may include a unique number generation module, and the unique number generation module may be configured to generate the unique number by using the input ID. The terminal may include a storage module, and may be configured to store the ID and the authentication key input in the storage module. The authentication sever may include a database (DB), and the ID, the authentication key, and the unique number may be stored in the DB.

Another exemplary embodiment of the present invention provides an automatic login method that may include: receiving an ID and a password; generating a unique number based on the ID; generating an authentication key by comparing the ID and the password with a previously stored ID and password; regenerating the unique number based on the ID; and approving an automatic login using the ID, the authentication key, and the unique regenerated number, and the stored ID, the stored authentication key, and the stored unique number.

The method may further include storing the input ID and the authentication key. In addition, the method may include storing the ID, the password, the authentication key, and the unique number. According to an exemplary embodiment of the present invention, the automatic login system and the automatic login may improve ID and password security.

### BRIEF DESCRIPTION OF THE DRAWINGS

The above and other objects, features and advantages of the present disclosure will be more apparent from the following detailed description taken in conjunction with the accompanying drawings.

FIG. 1 is an exemplary schematic block diagram illustrating an automatic login system according to an exemplary embodiment of the present invention; and

FIG. 2 is an exemplary flowchart illustrating an automatic login method according to an exemplary embodiment of the present invention.

### DETAILED DESCRIPTION

An exemplary embodiment of the present invention will hereinafter be described in detail with reference to the accompanying drawings. As those skilled in the art would realize, the described exemplary embodiments may be modified in various different ways, all without departing from the spirit or scope of the present invention. The drawings and description are to be regarded as illustrative in nature and not restrictive. Like reference numerals designate like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In addition, the terms “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

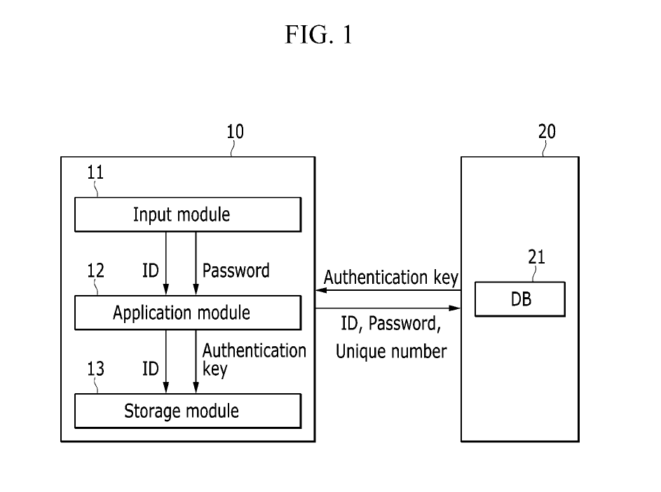

Referring to FIG. 1, an automatic login system according to an exemplary embodiment of the present invention will hereinafter be described in detail. FIG. 1 is an exemplary schematic block diagram illustrating an automatic login system according to an exemplary embodiment of the present invention.

An automatic login system according to an exemplary embodiment of the present invention may perform an initial login based on an input identification (ID) and a password. Further, the automatic login system may perform an automatic login based on a unique number and an authentication key. As shown in FIG. 1, an automatic login system according an exemplary embodiment of the present invention may include a terminal 10 and an authentication server 20, each which may be operated by a processor.

In particular, the terminal 10 may include an input module 11 into which an ID and a password of user may be input, an application module 12, and a storage module 13 configured to store the input ID and an authentication key. The application module 12 may be configured to generate a unique terminal number based on the input ID. The terminal 10 may be configured to transmit the input ID and the input password to the authentication server 20 and request an initial login. The terminal 10 may further be configured to store the authentication key and the input ID generated by the authentication server 20 in the storage module 13. The terminal 10 may be configured to regenerate the unique number of the terminal using the ID stored in the storage module 13 during re-login after an initial logoff. The terminal 10 may be configured to transmit the unique regenerated terminal number and the ID and authentication key stored in the storage module 13 to the authentication server 20, and request an automatic login.

The authentication server 20 may be configured to compare the input ID and the input password with a previously stored ID and password. When the input ID and the input password are the same as (e.g., match or correspond to) the previously stored ID and password, the authentication server 20 may be configured to generate an authentication key, transmit the authentication key to the terminal 10, and approve (e.g., authenticate) the initial login. The authentication server 20 may include a database (DB) 21, and the ID and the password may be stored in advance in the database 21. The authentication server 20 may also be configured to store the generated authentication key and the unique number.

In addition, the authentication server 20 may be configured to compare a regenerated terminal unique number, the ID and the authentication key transmitted from the terminal 10 with the ID, and the authentication key and the unique number stored in the data base 21 after the initial logoff. The authentication server 20 may be configured to approve an automatic login of the terminal 10 when the unique regenerated terminal number, the ID, and the authentication key transmitted from the terminal 10 are same as the ID, the authentication key, and the unique number stored in the database 21.

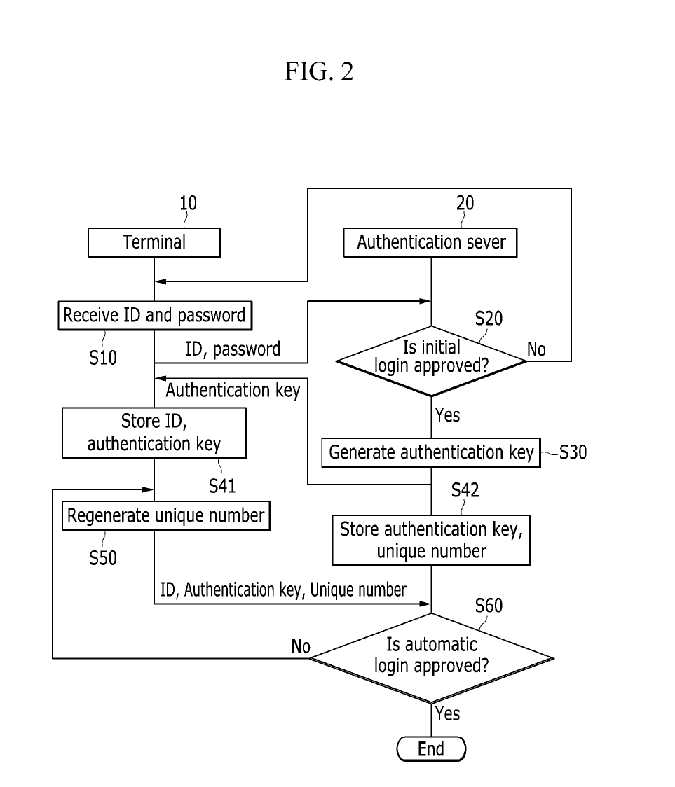

Referring to FIG. 2, an automatic login method according to an exemplary embodiment of the present invention will hereinafter be described in detail. FIG. 2 is an exemplary flowchart illustrating an automatic login method according to an exemplary embodiment of the present invention.

The terminal 10 may be configured to receive an ID and a password for an initial login from a user at step S10. The application module 12 may be configured to generate a unique number of the terminal 10 based on the input ID. The authentication server 20 may be configured to determine whether the initial login is approved at step S20. In particular, the authentication server 20 may be configured to approve the initial login when the ID and the password transmitted from the terminal 10 are same as the ID and the password stored in the database 21.

Further, when the initial login is approved at the step S20, the authentication server 20 may be configured to generate an authentication key and transmit the authentication key to the terminal 10 at step S30. The ID and the authentication key may be stored in a storage module 13 at step S41, and the authentication key and the unique number may be stored in a database 21 at step S42. After the initial login is approved, the user may use the terminal 10 and initially log off from the terminal. To access the terminal 10 again after the initial logoff, the terminal 10 may be configured to regenerate the unique number based on the input ID of the initial login at step S50. The authentication server 20 may be configured to approve an automatic login using the ID, the authentication key, and the unique regenerated number, and the stored ID, the stored authentication key, and the unique stored number. Accordingly, after the initial log off, a user may be automatically logged on again based on the previously stored information.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

### DESCRIPTION OF SYMBOLS

10: terminal

11: input module

12: application module

13: storage module

20: authentication server

21: database

What is claimed is:

1. An automatic login system, comprising:
a terminal configured to generate a unique number based on an input identification (ID) and store the ID and an authentication key; and
an authentication server configured to approve an initial login by comparing the input ID and an input password with a previously stored ID and password, and store the input ID, the input password, the authentication key, and the unique number,
wherein the terminal is further configured to regenerate the unique number based on the input ID, and
wherein the authentication server is further configured to approve an automatic login using the input ID, the authentication key, and the unique regenerated number, and the stored ID, the stored authentication key, and the stored unique number stored in the authentication server.

2. The automatic login system of claim 1, wherein the authentication server is configured to generate the authentication key when the input ID and the input password are the same as the stored ID and the stored password.

3. The automatic login system of claim 2, wherein the authentication server is configured to approve the automatic login when the ID, the authentication key, and the unique regenerated number are the same as the stored ID, the stored authentication key, and the stored unique number in the authentication server.

4. The automatic login system of claim 3, wherein the terminal includes an input module, and is configured to receive the ID and the password via the input module.

5. The automatic login system of claim 4, wherein the terminal includes a unique number generation module and the unique number generation module is configured to generate the unique number using the input ID.

6. The automatic login system of claim 5, wherein the terminal includes a storage module, and is configured to store the input ID and the authentication key input in the storage module.

7. The automatic login system of claim 6, wherein the authentication server includes a database (DB), and the ID, the authentication key, and the unique number are stored in the DB.

8. An automatic login method comprising:
receiving, by a processor, an identification (ID) and a password input;
generating, by the processor, a unique number based on the ID;
generating, by the processor, an authentication key by comparing the input ID and the input password with a previously stored ID and password;
regenerating, by the processor, the unique number based on the input ID; and
approving, by the processor, an automatic login using the ID, the authentication key and the unique regenerated number, and the stored ID, the stored authentication key, and the stored unique number.

9. The automatic login method of claim 8, further comprising:
storing, by the processor, the input ID and the authentication key.

10. The automatic login method of claim 9, further comprising:
storing, by the processor, the ID, the password, the authentication key, and the unique number.

11. A non-transitory computer readable medium containing program instructions executed by a processor, the computer readable medium comprising:
program instructions that receive an identification (ID) and a password input;
program instructions that generate a unique number based on the ID;
program instructions that generate an authentication key by comparing the input ID and the input password with a previously stored ID and password;
program instructions that regenerate the unique number based on the input ID; and
program instructions that approve an automatic login using the ID, the authentication key and the unique regenerated number, and the stored ID, the stored authentication key, and the stored unique number.

12. The non-transitory computer readable medium of claim 11, further comprising:
program instructions that store the input ID and the authentication key.

13. The non-transitory computer readable medium of claim 12, further comprising:
program instructions that store the ID, the password, the authentication key, and the unique number.
